(19) United States
(12) Patent Application Publication
(10) Pub. No.: US 2007/0177317 A1
(43) Pub. Date: Aug. 2, 2007

(54) ESD protection circuit

(75) Inventor: Young-chul Kim, Yongin-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/698,736

(22) Filed: Jan. 26, 2007

(30) Foreign Application Priority Data
Jan. 27, 2006 (KR) 10-2006-0009063

(51) Int. Cl. H02H 9/00

(52) U.S. Cl. 361/56

(57) ABSTRACT

A data input/output protection circuit capable of consistent protection against high input voltage and ESD includes: a pull-up unit that clamps static electricity introduced through a pad transmitting an input signal and having a transistor connected between a source voltage and the pad; a pull-down unit that clamps the static electricity introduced through the pad and having a plurality of transistors connected between a ground voltage and the pad; and a pull-down controller connected to the pull-down unit, the pull-down controller activating the plurality of transistors included in the pull-down unit concurrently in response to a voltage variation caused by the introduced static electricity when the introduced static electricity is clamped through the pull-down unit.

### CROSS-REFERENCE TO RELATED PATENT APPLICATION

This application claims priority under 35 U.S.C. 119 to Korean Patent Application No. 10-2006-0009063, filed on Jan. 27, 2006, in the Korean Intellectual Property Office, the disclosure of which is incorporated herein in its entirety by reference.

### BACKGROUND OF THE INVENTION

1. Field of the Invention

The present invention relates to an electrostatic discharge (ESD) protection circuit, and more particularly, to an ESD protection-circuit suitable for consistent protection against high input voltage and ESD.

2. Description of the Related Art

Semiconductor chips commonly include data input/output circuits which input/output data through a connective element referred to as a pad. In the semiconductor chip, an electrostatic discharge (ESD) protection circuit is further included to protect elements in the semiconductor chip against ESD. ESD is a phenomenon in which static electricity caused by friction between objects is discharged. ESD can be harmful to semiconductor devices that are exposed to the high-voltage discharge. An ESD protection circuit is inserted near the pad of the semiconductor chip, and is arranged between the pad and the main circuit of the chip. The ESD protection circuit protects the main circuit of the semiconductor chip against damage by discharging the introduced static electricity through an appropriate discharge path.

FIG. 1A is a circuit diagram of a conventional ESD protection circuit. As shown in FIG. 1A, the ESD protection circuit includes a PMOS transistor P1 having one electrode connected to a pad PAD and another electrode connected to a predetermined source voltage V_{DD}. In addition, the ESD protection circuit includes an NMOS transistor N1 having one electrode connected to the pad PAD and another electrode connected to a ground voltage Vss.

A gate and an N-well of the PMOS transistor P1 are connected to the source voltage V_{DD} to form one diode. A gate and a substrate of the NMOS transistor N1 are connected to the ground voltage Vss to form another diode. A high voltage or current is prevented from being applied to an internal circuit of the semiconductor chip by discharging static electricity that is introduced through the pad PAD through the PMOS transistor P1 and the NMOS transistor N1.

With the further integration of semiconductor devices, CMOS technology continues to develop. Accordingly, the source voltage used for the semiconductor chip decreases, and recently, an operation voltage below 3.3V is more commonly used. Therefore, the aforementioned semiconductor chip has to have tolerance against an applied excess voltage, or overvoltage, so that signals having an operation voltage of 5V can be transmitted to the chip.

FIG. 1B is a circuit diagram of a conventional ESD protection circuit with overvoltage tolerance. As shown in FIG. 1B, the ESD protection circuit includes a PMOS transistor P2 which is connected between a pad PAD and a source voltage V_{DD}. In addition, the ESD protection circuit includes two NMOS transistors N2 and N3, which are connected between the pad PAD and a ground voltage Vss.

A gate and an N-well of the PMOS transistor P2 are connected to the source voltage V_{DD}. A gate of the first NMOS transistor N2 is connected to the pad PAD and the source voltage V_{DD}. In addition, a gate electrode and a source electrode of the second NMOS transistor N3 are connected to the ground voltage Vss.

The voltage tolerance of a MOS transistor is generally 3V, so when a voltage of 5V is applied to the MOS transistor through the pad PAD, the first NMOS transistor N2 is turned on by the source voltage V_{DD}, for example 3.3 V, which is input into the gate of the first NMOS transistor N2. Accordingly, the input voltage of 5V is divided and input into one electrode of the second NMOS transistor N3. Therefore, in the above case, the NMOS transistor N3 of the ESD protection circuit is protected against damage.

When the overvoltage caused by ESD is applied to the NMOS transistor N3, it is preferable that the NMOS transistor N3 operate like a bipolar junction transistor (BJT) in a breakdown mode. However, when overvoltage and overcurrent caused by ESD are applied to the ESD protection circuit in FIG. 1B, a turn-on voltage is applied to the gate of the first NMOS transistor N2 through the line connecting the PMOS transistor P2 and the source voltage VDD, and accordingly, the first NMOS transistor N2 is turned on. The overcurrent is concentrated on an area on which a channel of the first NMOS transistor N2 is formed, and heat is generated even at low ESD levels, which causes damage to the elements.

FIG. 2 is a circuit diagram of another conventional ESD protection circuit. As shown in FIG. 2, a PMOS transistor P3 is connected between a pad PAD and a source voltage V_{DD}. Two serially connected NMOS transistors N4 and N5 are connected between the pad PAD and a ground voltage Vss. PMOS transistors P4 and P5 constitute a virtual floating well controller used to control the voltage applied to the gate and the N-well of the PMOS transistor P3. An NMOS transistor N6 can be further included to discharge the static electricity caused by ESD through the ground voltage Vss.

As shown in FIG. 2, an additional source voltage is applied to a gate of the first NMOS transistor N4. The turn-on voltage can be prevented from being applied to the gate of the first NMOS transistor N4 by applying the additional source voltage, and therefore, the current concentrating appearance at the first NMOS transistor N4 can be prevented. However, since the source voltage, which is generally used for a separate circuit, is used for the ESD protection circuit, the complexity of the design of the circuit increases. In addition, the circuit applying the voltage to the ESD protection circuit is required to operate together with the ESD protection circuit when the ESD protection circuit operates.

### SUMMARY OF THE INVENTION

Embodiments of the present specification provide an electrostatic discharge (ESD) protection circuit of relatively simple design that is capable of consistent protection against high input voltage and ESD without supplying an additional source voltage.

According to an aspect of the present invention, there is provided an ESD protection circuit including: a pull-up unit that clamps static electricity introduced through a pad transmitting an input signal and having a transistor connected between a source voltage and the pad; a pull-down unit that clamps the static electricity introduced through the pad and having a plurality of transistors connected between a ground voltage and the pad; and a pull-down controller connected to the pull-down unit, the pull-down controller activating the plurality of transistors included in the pull-down unit concurrently in response to a voltage variation caused by the introduced static electricity when the introduced static electricity is clamped through the pull-down unit.

The pull-down unit can include serially connected first and second NMOS transistors.

The pull-down controller can include a pull-down control transistor having a first electrode connected to the source voltage and a gate of the first NMOS transistor, and having a second electrode connected to a gate of the second NMOS transistor.

The ESD protection circuit can further include: a capacitor connected between the source voltage and the pull-down controller, the capacitor changing a voltage at a node connected to the pull-down controller when the static electricity is introduced; and a resistor connected between the capacitor and the ground voltage.

In another embodiment, one electrode of the capacitor is connected to the source voltage and another electrode of the capacitor is connected to the gate of the pull-down control transistor.

Alternatively, the ESD protection circuit further includes a gate coupled NMOS (GCNMOS) transistor connected between the source voltage and the ground voltage, the GCNMOS transistor clamping the static electricity introduced through the pad supplying the source voltage and the static electricity introduced through the pad transmitting the input signal.

According to another aspect of the present invention, there is provided an ESD (electrostatic discharge) protection circuit including: a pull-up unit that clamps static electricity introduced through a pad transmitting an input signal and having a transistor connected between a source voltage and the pad; a pull-down unit that clamps the static electricity introduced through the pad and having a plurality of transistors connected a ground voltage and the pad; a pull-down controller connected to the pull-down unit, the pull-down controller activating the plurality of the transistors included in the pull-down unit concurrently in response to a voltage variation caused by the introduced static electricity when the introduced static electricity is clamped through the pull-down unit; and a latch connected to the pull-down controller to ensure the plurality of transistors of the pull-down unit are activated when clamping the static electricity.

In one embodiment, the pull-down unit comprises serially connected first and second NMOS transistors.

In another embodiment, the pull-down controller comprises a pull-down control transistor having a first electrode connected to the source voltage and a gate of the first NMOS transistor, and having a second electrode connected to a gate of the second NMOS transistor.

In another embodiment, the latch is connected between a control node supplying a voltage for controlling the pull-down control transistor and a gate of the pull-down control transistor.

In another embodiment, the second electrode of the pull-down control transistor is further connected to a driver circuit.

In another embodiment, the ESD protection circuit further comprises a resistor connected between the second electrode of the pull-down control transistor and the ground voltage.

In another embodiment, the ESD protection circuit further comprises: a capacitor connected between the source voltage and the control node, the capacitor changing a voltage at the control node when the static electricity is introduced; and a resistor connected between the control node and the ground voltage.

In another embodiment, the ESD protection circuit further comprises a MOS transistor connected between the source voltage and the ground voltage, the MOS transistor clamping the static electricity introduced through the pad supplying the source voltage and clamping the static electricity introduced through the pad transmitting the input signal.

### BRIEF DESCRIPTION OF THE DRAWINGS

The above and other features and advantages of the present invention will become more apparent by describing in detail exemplary embodiments thereof with reference to the attached drawings in which:

FIG. 1A is a circuit diagram of a conventional ESD protection circuit;

FIG. 1B is a circuit diagram of a conventional ESD protection circuit with overvoltage tolerance;

FIG. 2 is a circuit diagram of another conventional ESD protection circuit;

FIG. 3 is a circuit diagram of an ESD protection circuit according to an embodiment of the present invention;

FIG. 4 is a circuit diagram of an ESD protection circuit according to another embodiment of the present invention; and

FIG. 5 is a circuit diagram of an example of a latch shown in FIG. 4.

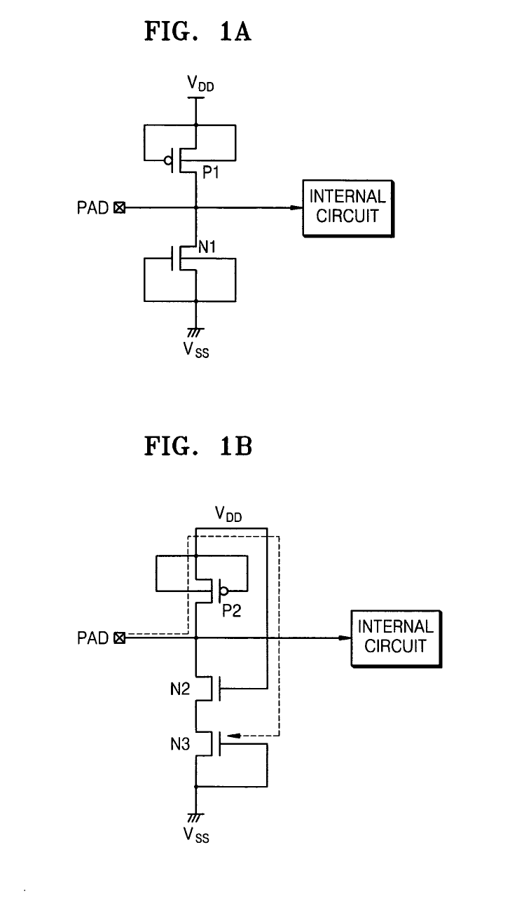

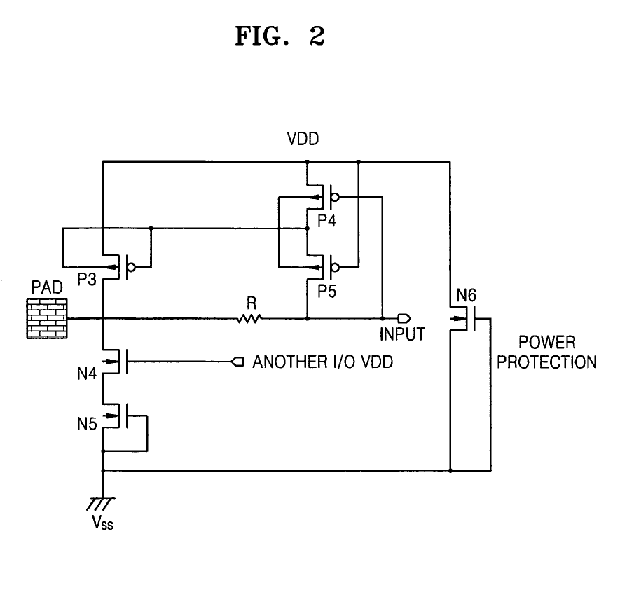

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete. Throughout the drawings, like reference numerals refer to like elements.

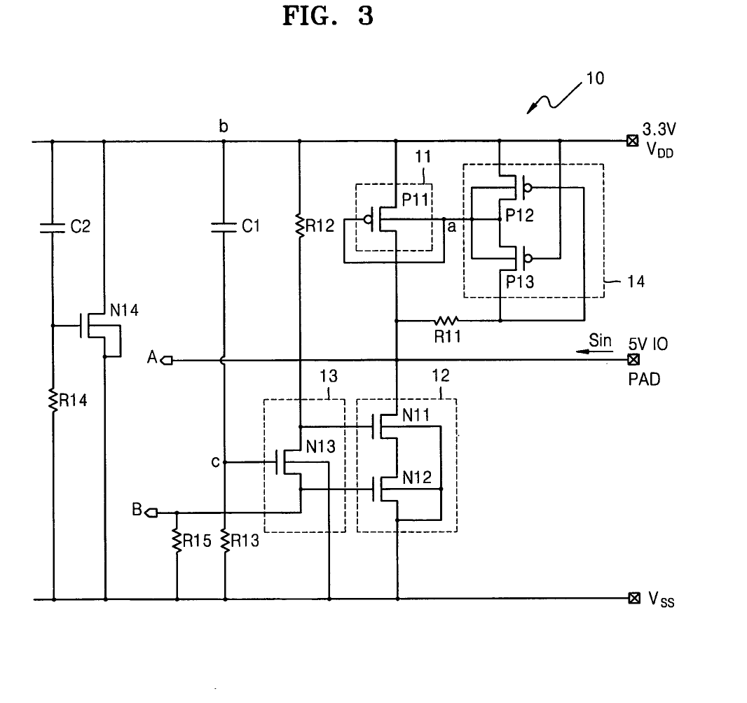

FIG. 3 is a circuit diagram of an ESD protection circuit according to an embodiment of the present invention. As shown in FIG. 3, the ESD protection circuit 10 can include a pull-up unit 11, a pull-down unit 12, and a pull-down controller 13.

The pull-up unit 11 is connected between a pad PAD transmitting an input signal Sin, for example, an input signal of 5V, and a predetermined source voltage VDD. The pull-up unit 11 clamps the static electricity that is input through the pad PAD. Preferably, the pull-up unit 11 includes a PMOS transistor P11. One electrode of the PMOS transistor P11 is connected to the pad PAD, and another electrode of the PMOS transistor P11 is connected to the source voltage VDD. In addition, a gate and an N-well of the PMOS transistor P11 can be connected to each other. In FIG. 3, the source voltage V_{DD} has an exemplary voltage level of 3.3V.

PMOS transistors P12 and P13 constitute a virtual floating well controller 14 used to control the voltage (for example, a voltage at a node a) applied to the gate and the N-well of the PMOS transistor P11. The virtual floating well controller 14 controls the voltage level at the node a to be equal to or greater than the voltage level of the pad PAD transmitting the input signal Sin.

In contrast, the pull-down unit 12 is connected between the pad PAD transmitting an input signal Sin and a ground voltage Vss. The pull-down unit 12 clamps the static electricity that is input through the pad PAD. Since the input signal Sin of 5V is transmitted through the pad PAD, the pull-down unit 12 includes a plurality of serially connected transistors to have overvoltage tolerance.

Preferably, the plurality of transistors includes first and second NMOS transistors N11 and N12. One electrode of the first NMOS transistor N11 is connected to the pad PAD. One electrode of the second NMOS transistor N12 is connected to the ground voltage Vss. In addition, substrates of the first and second NMOS transistors N11 and N12 can both be connected to the ground voltage Vss.

When the static electricity input through the pad PAD is clamped through the pull-down unit 12, the pull-down controller 13 controls the first NMOS transistor N11 and the second NMOS transistor N12 to be turned on concurrently. In detail, the pull-down controller 13 is connected between the pad PAD and the source voltage V_{DD}. The pull-down controller 13 controls the first NMOS transistor N11 and the second NMOS transistor N12 to be turned on concurrently in response to a voltage variation caused by the introduced static electricity.

Preferably, the pull-down controller 13 includes a pull-down control transistor. As shown in FIG. 3, the NMOS transistor N13 can be used as the pull-down control transistor. A first electrode of the pull-down control transistor N13 may be connected to the source voltage V_{DD} through a resistor R12. A second electrode of the pull-down control transistor N13 can be connected to a predetermined driver circuit through a node B. In addition, a substrate of the pull-down control transistor N13 can be connected to the ground voltage Vss. Although it is not shown, a PMOS transistor can be used as the pull-down controller 13. In the above case, the influence of the threshold voltage drop can be reduced, and therefore, a stable turn-on voltage can be applied to the first and second NMOS transistors N11 and N12. When the PMOS transistor is used as the pull-down controller 13, an inverter can be further included between the PMOS transistor and the node C.

The first electrode of the pull-down control transistor N13 can be further connected to the gate of the first NMOS transistor N11 so that the first and second NMOS transistors N11 and N12 of the pull-down unit 12 are turned on concurrently when the static electricity is introduced. In addition, the second electrode can be further connected to the gate of the second NMOS transistor N12.

A capacitor C1 which is connected between the node c and the source voltage V_{DD} can be further included. The capacitor C1 increases the voltage at the node c connecting the pull-down controller 13 when the static electricity is introduced. More particularly, the capacitor C1 can be connected between the source voltage V_{DD} and the gate of the pull-down control transistor N13. In addition, a resistor R13 can be further connected between the capacitor C1 and the ground voltage Vss.

Static electricity can, at times, be introduced through the pad transmitting the source voltage V_{DD}. A MOS transistor may be further connected between the source voltage V_{DD} and the ground voltage Vss to clamp the static electricity. For example, an NMOS transistor N14 of which the first and second electrodes are connected between the source voltage V_{DD} and the ground voltage Vss, respectively, and the substrate of which is connected to the second electrode, may be used as the aforementioned MOS transistor for clamping the static electricity. In addition, a capacitor C2 can be further connected between the source voltage V_{DD} and the gate of the NMOS transistor N14, and a resistor R14 can be connected between the gate of the NMOS transistor N14 and the ground voltage Vss. As arranged above, the NMOS transistor N14 can also clamp the static electricity introduced through the pad PAD transmitting the input signal Sin of 5V. A node A is connected to an internal circuit (not shown). The node A transmits the input signal Sin, which is transmitted to the internal circuit through the pad PAD.

Hereinafter, an operation of the aforementioned ESD protection circuit will be described.

First, when static electricity is input through the pad PAD, the voltage at the node b drastically varies through the line connecting the PMOS transistor P11 and the source voltage V_{DD}. As the voltage at the node b varies, a current flows through the capacitor C1. The current flows to the ground voltage through the resistor R13, and a voltage corresponding to the current flowing through the resistor R13 is applied to the node c.

The voltage applied to the node c is transmitted to the gate of the pull-down control transistor N13. Accordingly, the pull-down control transistor N13 is turned on. Accordingly, as the pull-down control transistor N13 is turned on, the voltages are applied to the gates of the first and second NMOS transistors N11 and N12.

Accordingly, as the first and second NMOS transistors N11 and N12 are concurrently turned on by the voltages applied to the gates of the first and second NMOS transistors N11 and N12, the static electricity introduced through the pad PAD is transmitted to the ground voltage Vss via the first and second NMOS transistors N11 and N12. Accordingly, the high current associated with the static electricity signal is prevented from being applied to the node A connected to the pad PAD, and therefore, the internal circuit (not shown) connected to the node A is protected against damage. In addition, any overcurrent is prevented from being concentrated on the first NMOS transistor N11 because the first and second NMOS transistors are activated concurrently, avoiding the limitations associated with the conventional architecture discussed above.

As shown in FIG. 3, the second electrode of the pull-down control transistor N13 can be connected to the node B. The node B can be connected to a predetermined driver circuit (not shown). In that case, no additional element is required for connecting the second electrode of the pull-down control transistor N13 to the ground voltage Vss.

However, when the driver circuit is not connected to the node B, a resistor R15 can be further connected between the node B and the ground voltage Vss to form a path of a current flowing to ground through the pull-down control transistor N13.

As shown in FIG. 3, one electrode of the NMOS transistor N14 is connected to the source voltage V_{DD}, and another electrode of the NMOS transistor N14 is connected to the ground voltage Vss. Preferably, the second electrode and the substrate of the NMOS transistor N14 can be connected to the ground voltage Vss. In addition, the gate of the NMOS transistor N14 can be connected between the resistor R14 and the capacitor C2 which is connected between the source voltage V_{DD} and the ground voltage Vss.

The aforementioned NMOS transistor N14 can clamp the static electricity when the static electricity is introduced through the pad to which the source voltage V_{DD} is applied. In addition, when the static electricity is introduced through the pad PAD transmitting the input signal Sin of 5V, the NMOS transistor N14 can clamp the static electricity through the line connecting PMOS transistor P11 and the source voltage V_{DD} and the NMOS transistor N14.

A virtual floating well controller 14 can include PMOS transistors P12 and P13. One electrode of the PMOS transistor P12 is connected to the source voltage V_{DD}, and another electrode of the PMOS transistor P12 is connected to one electrode of the PMOS transistor P13. In addition, a gate of the PMOS P12 can be connected to another electrode of the PMOS P13, and a gate of the PMOS transistor P13 can be connected to the source voltage V_{DD}. Further, N-wells of the PMOS transistors P12 and P13 are connected to an N-well of the PMOS transistor P11 of the pull-up unit 11 through the node a.

A parasitic diode (not shown) may exist between the N-wells of the PMOS transistors P11 to P13, and the source voltage V_{DD} and the pad PAD transmitting the input signal Sin. In the above case, the input signal Sin may leak toward the source voltage V_{DD} through the parasitic diode when receiving the input signal Sin of 5V. However, as constructed above, the virtual floating well controller 14 controls the voltage at the node a to be equal to or greater than the voltage at the node connecting the PMOS transistor P11 to the pad PAD. Accordingly, an inverse voltage is applied to the parasitic diode and leaking of the signal is prevented.

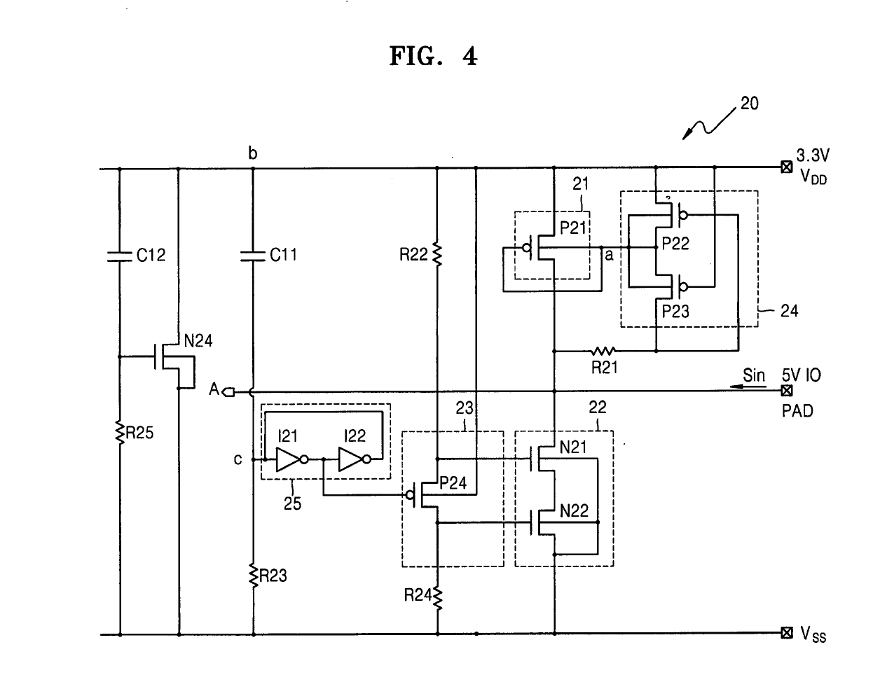

FIG. 4 is a circuit diagram of an ESD protection circuit according to another embodiment of the present invention. Detailed description of elements of the ESD protection circuit of FIG. 4 that are the same as the elements of the aforementioned ESD protection circuit will be omitted.

As shown in FIG. 4, the ESD protection circuit 20 according to another embodiment of the present invention can include a pull-up unit 21, a pull-down unit 22, and a pull-down controller 23. The pull-up unit 21 can include a PMOS transistor P21, and the pull-down unit 22 can include serially connected first and second NMOS transistors N21 and N22.

The pull-down controller 23 can include a pull-down control transistor P24. A first electrode of the pull-down control transistor P24 is connected to a gate of the first NMOS transistor N21, and a second electrode of the pull-down control transistor P24 is connected to a gate of the second NMOS transistor N22. In the current embodiment, the pull-down control transistor P24, in FIG. 4, is realized by a PMOS transistor, however the pull-down control transistor P24 is not restricted to only such a device, and can comprise any suitable circuit or device.

The ESD protection circuit 20 can further include a virtual floating well controller 24, and the virtual floating well controller 24 may include PMOS transistors P22 and P23. The virtual floating well controller 24 controls the voltage level at the node a to be equal to or greater than the voltage level at the node connected to the pad PAD transmitting the input signal Sin.

The ESD protection circuit 20 can further include an NMOS transistor N24 of which one electrode is connected to the source voltage V_{DD} and another electrode is connected to the ground voltage Vss. The ESD protection circuit can further include a capacitor C12 and a resistor R25 connected to a gate of the NMOS transistor N24. Accordingly, when the static electricity is introduced through the pad receiving the source voltage V_{DD}, the static electricity is clamped. In addition, when the static electricity is introduced through the pad transmitting the input signal Sin of 5V, the static electricity is clamped via the PMOS transistor P21, the source voltage V_{DD}, and the NMOS transistor N24.

According to an embodiment of the present invention, the ESD protection circuit can further include a latch 25 connected between the node c and the gate of the pull-down control transistor P24. The latch 25 may include a plurality of inverters, for example, two inverters I21 and I22.

In general, when static electricity is introduced, considering the characteristics of overvoltage and overcurrent caused by the static electricity, 90% of the overvoltage and the overcurrent is concentrated during the first 10 ns after the static electricity is introduced, and 99% of the overvoltage and the overcurrent is concentrated for the first 1 μs after the static electricity is introduced. Accordingly, it is important that the voltage at the node c is maintained at the required voltage level for about 1 μs.

To maintain the voltage at the node c, the values of the capacitor C11 and the resistor R23 can be modified, and particularly, the value of the capacitor C11 can be increased to, in turn, increase the RC value of resistance * capacitance (for example R23*C11). However, as the capacitance of the capacitor C11 is increased, the size of the semiconductor chip is increased.

Accordingly, it is preferable that the voltage at the node c is maintained for a specific time by including the latch 25 between the node c and the gate of the pull-down control transistor P24. In addition, even though it is not shown, in the plurality of inverters I21 and I22 included in the latch 25, the source voltage V_{DD} and the ground voltage Vss are used as bias voltages. Therefore, when receiving the static electricity through the pad PAD, the plurality of inverters I21 and I22 can be driven by the bias voltage.

A resistor R24 can be connected between the second electrode of the pull-down control transistor P24 and the ground voltage Vss. When the second electrode of the pull-down control transistor P24 is connected to a predetermined driver circuit (not shown), the resistor R24 need not be included.

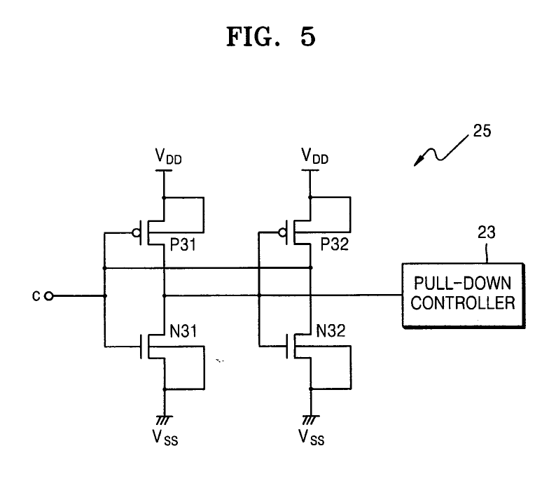

FIG. 5 is a circuit diagram of an example of the latch shown in FIG. 4. As shown in FIG. 5, the latch 25 in FIG. 4 can be connected between the node c and the pull-down controller 23 and can be embodied as a CMOS type.

When the latch 25 includes two inverters, that is, the first and second inverters I21 and I22, the first inverter I21 includes a PMOS transistor P31 and a NMOS transistor N31, and the second inverter I22 includes a PMOS transistor P32 and a NMOS transistor N32. As constructed above, the latch 25 can maintain the voltage at the node c for a specified time period.

As described above, according to the ESD protection circuit of the present invention, the design is relatively simple since supplying an additional source voltage is not necessary, and consistent protection against high input voltage and ESD is provided.

While the present invention has been particularly shown and described with reference to exemplary embodiments thereof, it will be understood by those of ordinary skill in the art that various changes in form and details may be made herein without departing from the spirit and scope of the present invention as defined by the following claims.

What is claimed is:

1. An ESD (electrostatic discharge) protection circuit comprising:
a pull-up unit that clamps static electricity introduced through a pad transmitting an input signal, the pull-up unit having a transistor connected between a source voltage and the pad;
a pull-down unit that clamps the static electricity introduced through the pad, the pull-down unit having a plurality of transistors connected between a ground voltage and the pad; and
a pull-down controller connected to the pull-down unit, the pull-down controller activating the plurality of transistors comprising the pull-down unit concurrently in response to a voltage variation caused by the introduced static electricity when the introduced static electricity is clamped through the pull-down unit.

2. The ESD protection circuit of claim 1, wherein the pull-down unit comprises serially connected first and second NMOS transistors.

3. The ESD protection circuit of claim 2, wherein the pull-down controller comprises a pull-down control transistor having a first electrode connected to the source voltage and a gate of the first NMOS transistor, and having a second electrode connected to a gate of the second NMOS transistor.

4. The ESD protection circuit of claim 3, wherein the second electrode of the pull-down control transistor is further connected to a driver circuit.

5. The ESD protection circuit of claim 3, further comprising a resistor connected between the second electrode of the pull-down control transistor and the ground voltage.

6. The ESD protection circuit of claim 3, further comprising:
a capacitor connected between the source voltage and the pull-down controller, the capacitor changing a voltage at a node connected to the pull-down controller when the static electricity is introduced; and
a resistor connected between the capacitor and the ground voltage.

7. The ESD protection circuit of claim 6, wherein one electrode of the capacitor is connected to the source voltage and another electrode of the capacitor is connected to a gate of the pull-down control transistor.

8. The ESD protection circuit of claim 1, further comprising a MOS transistor connected between the source voltage and the ground voltage, the MOS transistor clamping the static electricity introduced through the pad supplying the source voltage and clamping the static electricity introduced through the pad transmitting the input signal.

9. An ESD (electrostatic discharge) protection circuit comprising:
a pull-up unit that clamps static electricity introduced through a pad transmitting an input signal and having a transistor connected between a source voltage and the pad;
a pull-down unit that clamps the static electricity introduced through the pad and having a plurality of transistors connected between a ground voltage and the pad;
a pull-down controller connected to the pull-down unit, the pull-down controller activating the plurality of transistors comprising the pull-down unit concurrently in response to a voltage variation caused by the introduced static electricity when the introduced static electricity is clamped through the pull-down unit; and
a latch connected to the pull-down controller to ensure the plurality of transistors of the pull-down unit are activated when clamping the static electricity.

10. The ESD protection circuit of claim 9, wherein the pull-down unit comprises serially connected first and second NMOS transistors.

11. The ESD protection circuit of claim 10, wherein the pull-down controller comprises a pull-down control transistor having a first electrode connected to the source voltage and a gate of the first NMOS transistor, and having a second electrode connected to a gate of the second NMOS transistor.

12. The ESD protection circuit of claim 11, wherein the latch is connected between a control node supplying a voltage for controlling the pull-down control transistor and a gate of the pull-down control transistor.

13. The ESD protection circuit of claim 12, wherein the second electrode of the pull-down control transistor is further connected to a driver circuit.

14. The ESD protection circuit of claim 12, further comprising a resistor connected between the second electrode of the pull-down control transistor and the ground voltage.

15. The ESD protection circuit of claim 12, further comprising:
a capacitor connected between the source voltage and the control node, the capacitor changing a voltage at the control node when the static electricity is introduced; and
a resistor connected between the control node and the ground voltage.

16. The ESD protection circuit of claim 9, further comprising a MOS transistor connected between the source voltage and the ground voltage, the MOS transistor clamping the static electricity introduced through the pad supplying the source voltage and clamping the static electricity introduced through the pad transmitting the input signal.
